(19) United States
(12) Patent Application Publication
(10) Pub. No.: US 2014/0165808 A1
(43) Pub. Date: Jun. 19, 2014

(54) CUTTER CARTRIDGE AND CUTTING APPARATUS

(71) Applicant: Shinya Fujihara, Obu-shi (JP)

(72) Inventor: Shinya Fujihara, Obu-shi (JP)

(73) Assignee: BROTHER KOGYO KABUSHIKI KAISHA, Nagoya-shi (JP)

(21) Appl. No.: 14/106,089

(22) Filed: Dec. 13, 2013

(30) Foreign Application Priority Data
Dec. 17, 2012 (JP) 2012-274543

(51) Int. Cl. B26D 7/26; B26F 1/38

(52) U.S. Cl. CPC B26D 7/2614; B26F 1/3813
USPC 83/284; 83/698.11

(57) ABSTRACT

A cutter cartridge includes a chuck shaft, a sleeve, a connection unit configured to connect the sleeve to the chuck shaft, a chuck located inside the sleeve and formed by combining a first chuck member formed with a first contact brought into contact with one of flat sides and a side edge of the cutter and a second chuck member formed with a second contact contacting with the other flat side and. the side edge of. the cutter, the chuck causing the cutter to face an outside of the sleeve from an end of the sleeve located opposite the chuck shaft, and a conversion unit configured to convert movement of the sleeve and the chuck shaft in a direction such that both come close to each other to .movement in a direction of a shaft center, transmitting the converted movement to the first and second chuck members.

### CROSS-REFERENCE TO BELATED APPLICATIONS

This application is based upon and claims the benefit or priority from the prior Japanese Patent Application No. 2012-274543 filed on Dec. 17, 2012, the entire contents of which are incorporated herein by reference.

### BACKGROUND

1. Technical Field

The present disclosure relates to a cutter cartridge holding a cutter and a cutting apparatus provided with the cutter cartridge.

2. Related Art

Cutting apparatuses such as cutting plotters have conventionally been known which cut an object to be cut, such as paper, according to cutting data thereby to obtain a predetermined pattern. The cutting plotters include a cutter cartridge having a band plate, a shaft and a holder. The band plate is formed with a blade. The shaft is provided with a collet chuck which nips the band plate. The shaft is rotatably supported by the holder. When the band plate is nipped by the collet chuck, a distal end (a lowermost end) of the blade is displaced front a central axis of the shaft. The cutter and an object to be cut or a sheet of paper are moved relative to each other while the cutter is attached to a pen carriage and the blade is in contact with the paper, so that the paper is cut into a predetermined shape. Furthermore, the blade needs to be replaced by a new one since the blade is gradually worn by a cutting operation. In the above-described construction, the band plate formed with the blade can be replaced easily.

The collet chuck, however, merely nips and fixes the band plate in a direction of thickness of the band. Accordingly, in replacing the band plate by a new one, the position of the blade distal end is sometimes displaced relative to the central axis of the shaft depending upon a mounting manner. When the blade distal end is displaced relative to the central axis of the shaft, a cutting position of the object is also displaced from a proper position, with the result that the shape of the cut object becomes misshapen. This entails a problem.

### SUMMARY

Therefore, an object of the disclosure is to provide a cutter cartridge which uses a flat cutter and can prevent positional displacement of the blade distal end of the cutter due to replacement of the cutter and can improve a working efficiency in replacement of the cutter, and a cutting apparatus provided with the aforementioned cutter cartridge.

The present disclosure provides a cutter cartridge including a chuck shaft having a shaft portion about which a carriage of a cutting apparatus is rotated, the chuck shaft having an end, a sleeve which is cylindrical in shape and provided in the end of the chuck shaft, a connection unit configured to connect the sleeve to the chuck shaft so that the sleeve is movable in an axial direction of the shaft, a chuck provided inside the sleeve and configured into a columnar shape by combining a first chuck member formed with a first contact brought into contact with one of flat sides and a side edge of the cutter and a second chuck member formed with a second contact brought into contact with the other flat side and the side edge of the cutter, the chuck exposing the cutter from an end located opposite the chuck shaft to hold the cutter between the first, and second contacts, the chuck causing the cutter to face an outside of the sleeve from an end of the sleeve located opposite the chuck shaft, and a conversion unit configured to convert movement of the sleeve and the chuck shaft in a direction such that both come close to each other to movement in a direct ion of a center of the shaft, transmitting the converted movement to the first and second chuck members.

The disclosure also provides a cutting apparatus including a carriage provided with a cartridge holder to which a cutter cartridge is detachably attachable and a moving unit configured to move an object to be out and the carriage relative to each other. The cutter cartridge includes a chuck shaft having a shaft portion about which the carriage is rotated, the chuck shaft having an end, a sleeve which is cylindrical in shape and provided in the end of the chuck shaft, a connection unit configured to connect the sleeve to the chuck shaft so that the sleeve is movable in an axial direction of the shaft, a chuck provided inside the sleeve and configured into a columnar shape by combining a first chuck member formed with a first contact contacting with one of flat sides and a side edge of the cutter and a second chuck member formed with a second contact brought into contact with the other flat side and the side edge of the cutter, the chuck exposing the cuter from an end located opposite the chuck shaft to hold the cutter between the first and second contacts, the chuck causing the cutter to face an outside of the sleeve from an end of the sleeve located opposite the chuck shaft, and a conversion unit configured to convert movement of the sleeve and the chuck shaft in a direction such that both come close to each other to movement in a direction of a center of the shaft, transmitting the converted movement to the first and second chuck members.

### BRIEF DESCRIPTION OF THE DRAWINGS

In the accompanying drawings:

FIG. 1 is a perspective view of a cutting apparatus according to a first example;

FIG. 2 is a plan view of the cutting apparatus with a body cover being removed;

FIG. 3 is a front view of the cutting apparatus with the body cover being removed;

FIG. 4 is a front view of a cutter cartridge;

FIG. 5 is a longitudinal section of the cutter cartridge, showing the inner structure thereof;

FIG. 6 is an exploded longitudinal section of the cutter cartridge;

FIG. 7 is a longitudinal section of a chuck unit;

FIG. 8 is a longitudinal section taken along line VIII-VIII in FIG. 7;

FIG. 9 is a cross section taken along line IX-IX in FIG. 7;

FIGS. 10A and 10B are a plan view and a side elevation of a first chuck member respectively;

FIGS. 11A and 11B are a plan view and a side elevation of a second chuck member respectively;

FIGS. 12A and 12B are a plan view and a side elevation of a cutter;

FIG. 13 shows a chuck employed in the cutting apparatus in accordance with a second example;

FIG. 14 is a partially broken view taken along line XIV-XIV in FIG. 13; and

FIG. 15 is a cross section taken along line XV-XV in FIG. 13.

### DETAILED DESCRIPTION

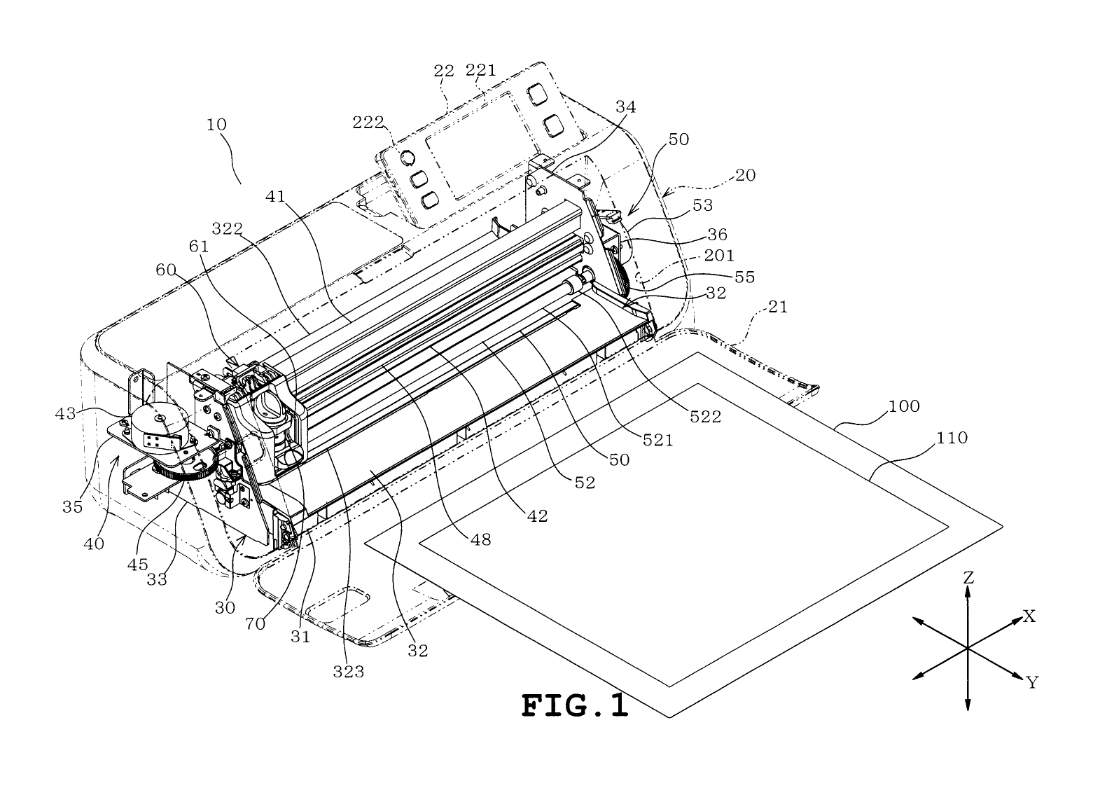

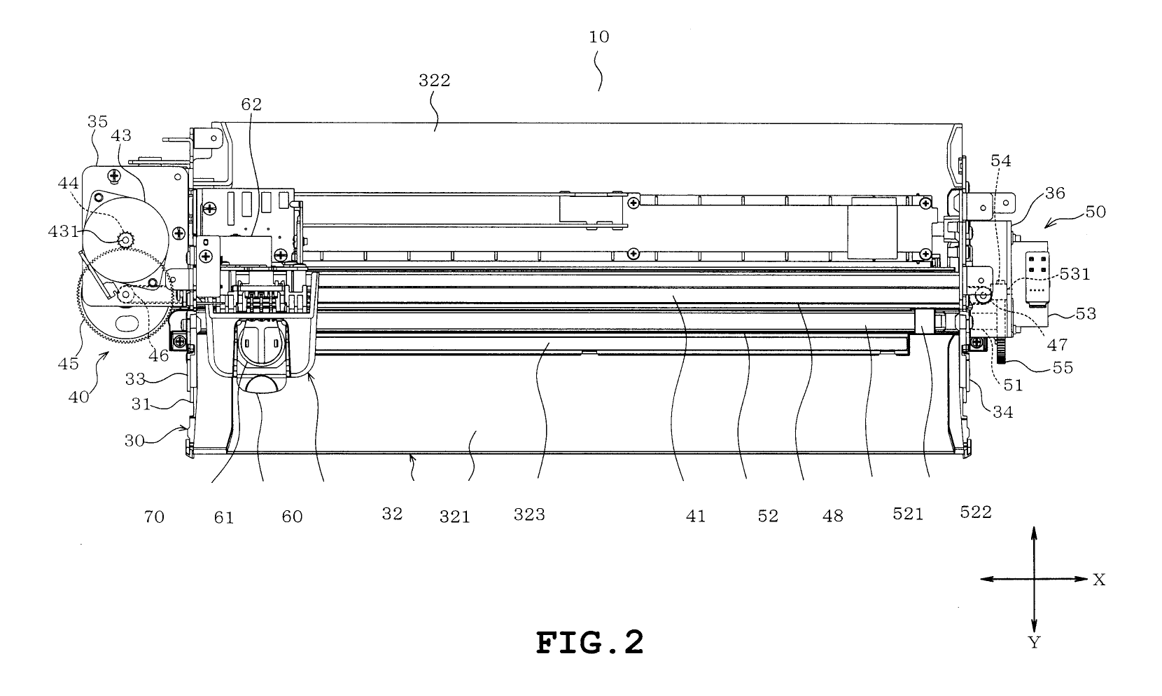

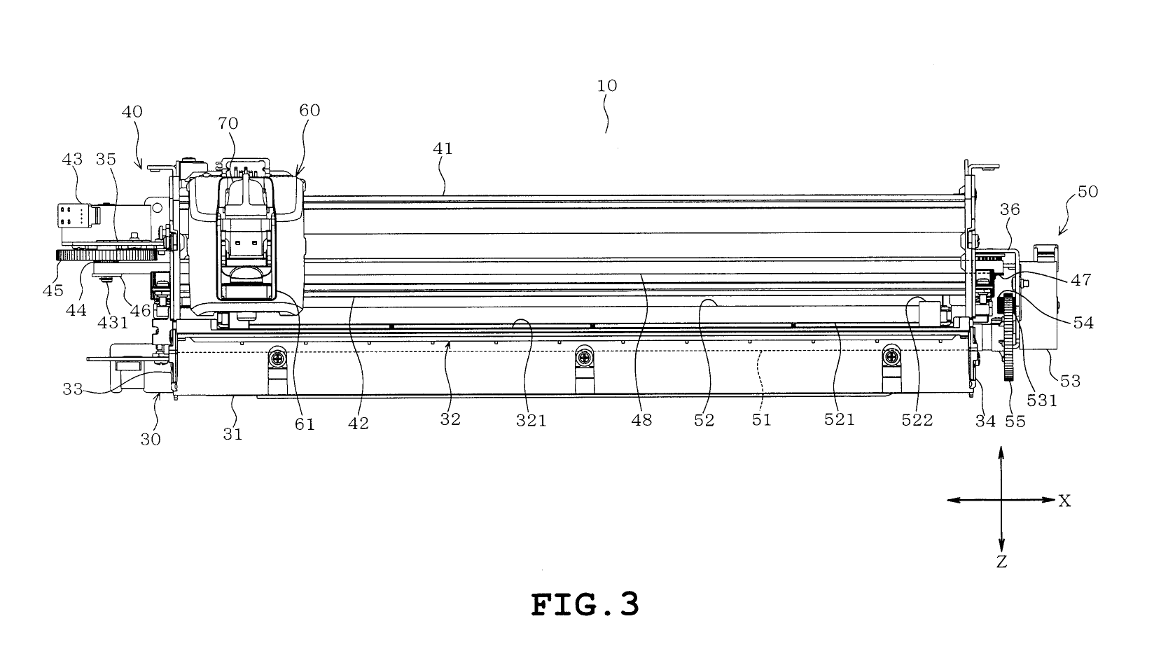

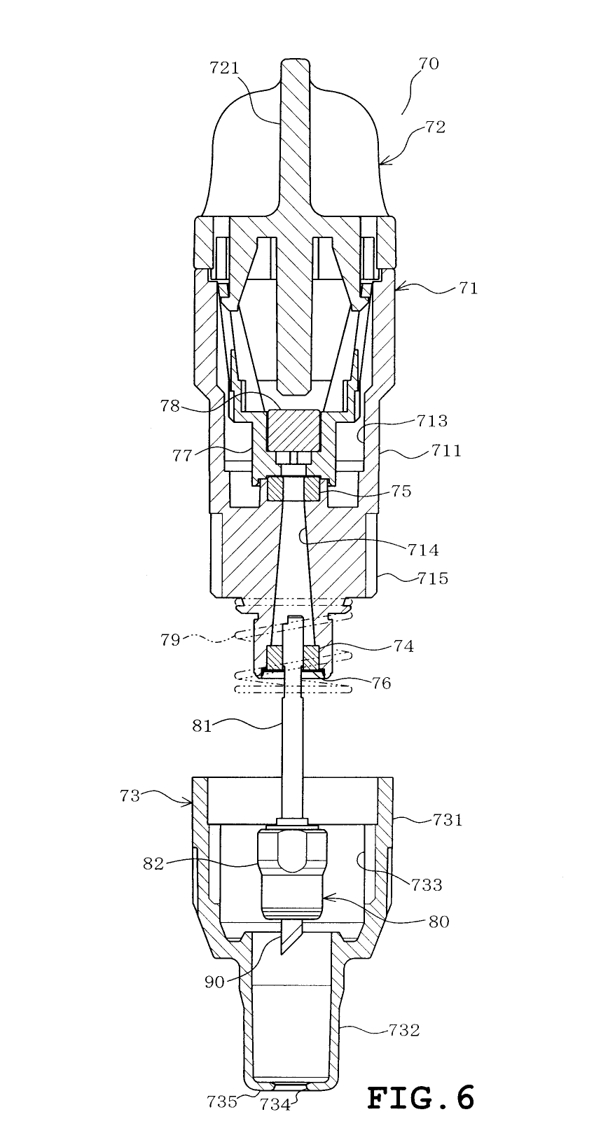

A first example will be described with reference to FIGS. 1 to 12. Referring to FIG. 1, the cutting apparatus 10 of the first example is configured to cut an object 110 to be cut, such as paper or cloth, held on a holding sheet 100. The holding sheet 100 is formed of a resin sheet having an adhesive layer (not shown) on a surface thereof. The object 110 is affixed to the adhesive layer to be held on the holding sheet 100.

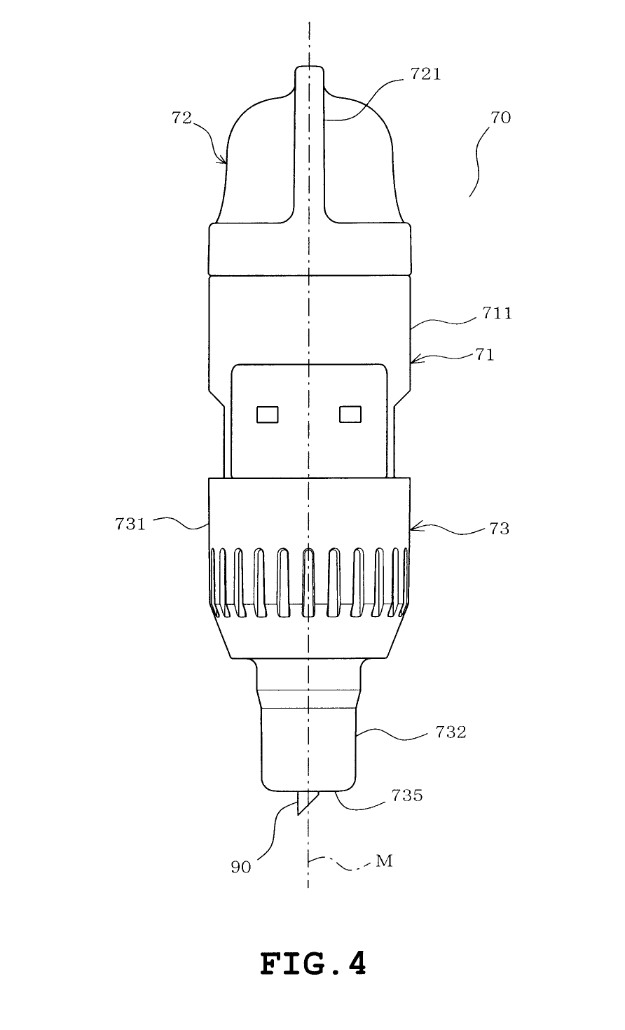

The cutting apparatus 10 includes a body cover 20, a body 30, an X-axis moving mechanism 40, a Y-axis moving mechanism 50, a carriage 60 and a cutter cartridge 70, as shown in FIGS. 1 to 3. The cutter cartridge 70 is detachably attached to the carriage 60. A cutter 90 as shown in FIG. 4 is replaceably attached to the cutter cartridge 70.

The body cover 20 is formed into a rectangular box shape as a whole and covers the body 30, the X-axis moving mechanism 40, the Y-axis moving mechanism 50, the carriage 60 and the cutter cartridge 70. In the following description, a longitudinal direction of the body cover 20 is defined as a right-left direction of the cutting apparatus 10. A side where an opening 201 is located is referred to as a front of the cutting apparatus 10. The right-left direction of the cutting apparatus 10 is defined as an X direction and a front-rear direction of the cutting apparatus 10 is defined as a Y direction. An up-down direction of the cutting apparatus 10 is defined as a Z direction. The body cover 20 has a front formed with an opening 201. The body cover 201 also has a rear located opposite the opening 201. The rear of the body cover 20 is also formed with an opening (not shown) through which the holding sheet 100 is passable.

The body cover 20 has a front cover 21 and an operation panel 22. The front cover 21 includes a lower end at which the front cover 21 is pivotally mounted on the body cover 20, so that the body cover 20 is caused to pivot between a position (see FIG. 1) where the opening 201 is opened and a position at which the opening 201 is closed. The operation panel 22 is mounted in a top of the body cover 20 and includes a liquid crystal display 221 and a plurality of switches 222. A user operates the operation panel 22 to perform the various setting and confirmation of an operating condition.

The body 30 includes a base 31, a receiving mechanism 32, right and left sidewalls 33 and 34 and right and left mounts 35 and 36. The base 31 is mounted on the bottom of the body cover 20 and formed into a rectangular frame shape. The receiving mechanism 32 has a front plate 321, a rear plate 322 and a platen 323. The front plate 321 is disposed in front of the carriage 60 over the base 31. The rear plate 322 is disposed in the rear of the carriage 60 over the base 31. Each of the front and rear plates 321 and 322 is formed into a generally horizontal flat plate shape.

The platen 323 is disposed between the front and rear plates 321 and 322 and formed into the shape of a rectangular plate long in the right-left direction. The platen 323 is located below the cutter cartridge 70 mounted on the carriage 60, so that the platen 323 is subjected to a pressing force the lower end of the cutter cartridge 70 applies to the object 110 and the holding sheet 100 when the object 100 is cut.

The front cover 21 is provided with a plurality of protrusions (not shown) which are configured so that heightwise positions of upper ends of the protrusions substantially correspond with heightwise positions of upper surfaces of the front and rear plates 321 and 322 when the front cover 21 is located at the open position. As a result, the holding sheet 100 becomes substantially horizontal when placed over upper surfaces of the front cover 21, the front plate 321 and the rear plate 322.

Each of the right and left sidewalls 34 and 33 is formed into a flat plate shape. The right and left sidewalls 34 and 33 are disposed opposite each other with the base 31 being interposed therebetween. The left sidewall 33 is mounted at the left end side of the base 31 while the right sidewall 34 is mounted at the right end side of the base 31. The left mount 35 is formed into a flat plate shape and extends horizontally leftward from an outer surface of the left sidewall 33. Parts and components constituting the X-axis moving mechanism 40 are mounted on the left mount 35. The right mount 36 is formed into a flat plate shape and extends horizontally rightward from an outer surface of the right sidewall 34 with a leading end being bent downward. Parts and components constituting the Y-axis moving mechanism 50 are mounted on the right mount 36.

The X-axis moving mechanism 40 moves the carriage 60 in the X direction or the right-left direction. The X-axis moving mechanism 40 includes a pair of upper and lower X-axis guide rails 41 and 42, an X-axis motor 43, an X-axis driving gear 44, an X-axis driven gear 45, a pair of timing pulleys 46 and 47 and a timing belt 48. The upper and lower X-axis guide rails 41 and 42 are disposed between the right and left sidewalls 34 and 33. The upper X-axis guide rail 41 and the lower X-axis guide rail 42 extend in parallel with each other. The X-axis guide rails 41 and 42 extend in the right-left direction along the lengthwise direction of the body cover 20 thereby to connect between the right and left side walls 34 and 33. The carriage 60 is configured to slide along the X-axis guide rails 41 and 42.

The X-axis motor 43 is comprised of a stepping motor, for example. The X-axis motor 43 is mounted on an upper surface of the left mount 35 and has an X-axis rotating shaft 431, which extends downward through the left mount 35, protruding down the left mount 35. The X-axis driving gear 44 is mounted on a lower end of the X-axis rotating shaft 431 and rotated together with the X-axis rotating shaft 431. The X-axis driven gear 45 is mounted on the underside of the left mount 35 so that a rotating shaft thereof is directed in the up-down direction. The X-axis driven gear 45 is in mesh engagement with the X-axis driving gear 44.

The left timing pulley 46 is disposed below the X-axis driven gear 45 so as to be rotated together with the X-axis driven gear 45. The right timing pulley 41 is disposed below the underside of the right mount 36. The timing belt 48 extends between the right and left timing pulleys 47 and 46. A part of the timing belt 48 is connected to the carriage 60 although not shown in detail.

Upon rotation of the X-axis motor 43, its rotation is transmitted via the X-axis driving gear 44, the X-axis driven gear 45 and the left timing pulley 46 to the timing belt 48. As a result, the carriage 60 is moved in the X direction or the right-left direction with the movement of the timing belt 48.

The Y-axis moving mechanism 50 is configured to move the object 110 held on the holding sheet 100 in the Y direction or the front-rear direction. The Y-axis moving mechanism includes a driving roller 51, a pinch roller 52, a Y-axis motor 53, a Y-axis driving gear 54 and a Y-axis driven gear 55. Both the driving roller 51 and the pinch roller 52 are rotatably mounted between the right and left sidewalls 34 and 33. The rollers 51 and 52 are disposed in parallel, with the X-axis guide rails 41 and 42 so that shaft centers of the rollers 51 and 52 are directed in the right-left direction, that is, in the X direction between the platen 323 and the upper and lower X-axis guide rails 41 and 42 in the front-rear direction.

The driving roller 51 is formed so as to have a uniform diameter substantially over an entire axial region. The driving roller 51 has an outer periphery with an upper end which is set to be located slightly higher than upper surfaces of the front and rear plates 321 and 322 of the receiving mechanism 32. The driving roller 51 has a right end protruding through the right sidewall 34 to the right mount 36 side.

The pinch roller 52 is disposed above the driving roller 51 and includes a roller shaft 521 made of a metal and a roller portion 522 which is made of a resin and is disposed near both ends of the roller shaft 521. The roller portion 522 has a larger outer diameter than the roller shaft 521 and is mounted on the outer periphery of the roller shaft 521. The pinch roller 52 is supported by the right and left sidewalls 34 and 33 so as to be movable in the up-down direction and rotatable. The pinch roller 52 is urged downward, that is, to the driving roller 51 side by coil springs (not shown) disposed at both ends of the roller shaft 521 respectively. Accordingly, the holding sheet 100 disposed between the driving roller 51 and the pinch roller 52 is pressed against the driving roller 51 by the roller portion 522.

The Y-axis motor 53 is comprised of a stepping motor, for example and mounted on a right side of the right mount 36. The Y-axis motor 53 has a Y-axis rotating shaft 531 which protrudes through the right mount 36 in the right-left direction to the left of the right mount 36. The Y-axis driving gear 54 is mounted on a distal end of the Y-axis rotating shaft 531 thereby to be rotated together with the Y-axis rotating shaft 531. The Y-axis driven gear 55 is mounted on a right end of the driving roller 51 in the left of the right mount 36 thereby to be rotated together with the driving roller 51. The Y-axis driven gear 55 is in mesh engagement with the Y-axis driving gear 54.

Upon rotation of the Y-axis motor 53, its rotation is transmitted to the driving roller 51 by the Y-axis driving gear 54 and the Y-axis driven gear 55. Rotation of the driving roller 51 is transmitted to the holding sheet 100 held between the driving roller 51 and the pinch roller 52. As a result, the holding sheet 100 is moved in the Y direction perpendicular to an axial direction of the driving roller 51, that is, in the front-rear direction.

The carriage 60 has a cartridge holder 61 and a Z-axis moving mechanism (not shown). The cartridge holder 61 is disposed in front of the carriage 60 to detachably hold the cutter cartridge 70. The cutter cartridge 70 is fixed to the cartridge holder 61 while a flat plate-shaped cutter 90 is attached to a lower end of the cutter cartridge 70 as shown in FIG. 4. The X-axis moving mechanism (not shown) is disposed inside the carriage 60 to move the cartridge holder 61 in the up-down direction or in the Z-axis direction together with the cutter cartridge 70.

When the cartridge holder 61 is moved downward by the Z-axis moving mechanism, a distal end of the cutter 30 attached to the cutter cartridge 70 bites into the object 110 held by the holding sheet 100. With the distal end of the cutter 90 being biting into the object 110, the carriage 60 is moved in the X direction by the X-axis moving mechanism 40 and the object 110 is moved in the Y direction by the Y-axis moving mechanism 50. Consequently, the object 110 is cut into a desired shape by the cutting apparatus 10. In this case, the X-axis and Y-axis moving mechanisms 40 and 50 function as a relative moving unit which moves the object 110 and the carriage 60 relative to each other.

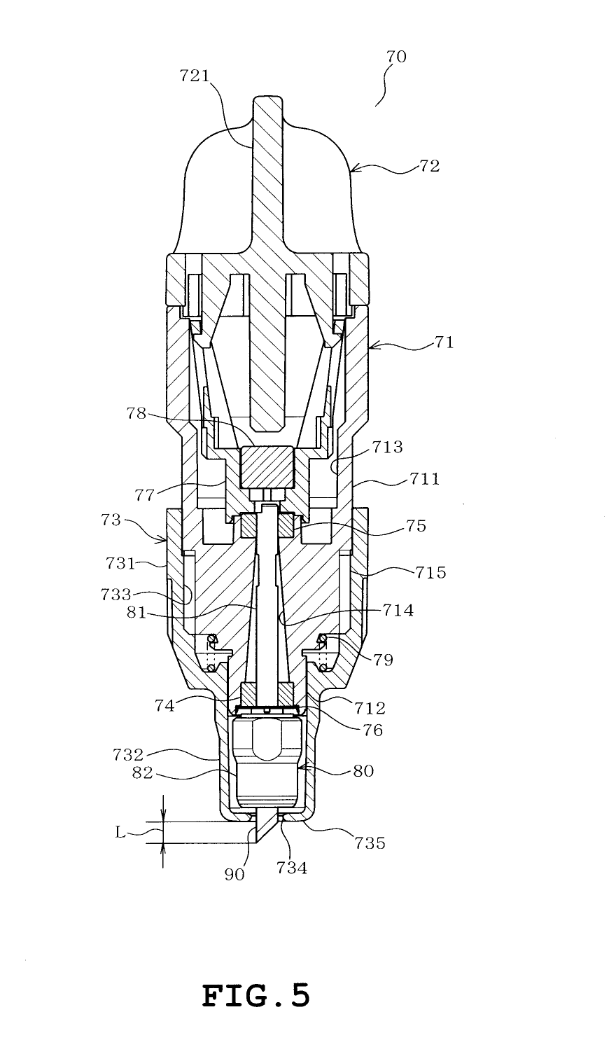

The cutter cartridge 70 includes a cartridge body 71, a dog 72, a cap 73 and a chuck unit 80. The cartridge body 71 is made of a resin and is long in the up-down direction as a whole. The cartridge body 71 is formed into a two-stage columnar shape such that the cap 73 has a lower part having a smaller diameter than an upper part as a whole. More specifically, as shown in FIG. 5, the cartridge body 71 includes a body larger-diameter portion 711 and a body smaller-diameter portion 712 both of which are formed integrally therewith. The larger-diameter portion 711 is formed into a generally cylindrical shape. The smaller-diameter portion 712 is disposed under the larger-diameter portion 711. The smaller-diameter portion 712 is formed into a cylindrical shape and has a smaller outer diameter than the larger-diameter portion 711.

A housing 713 and an insertion part 714 are defined in an interior of the cartridge body 71. The housing 713 is located in the larger-diameter portion 711 and is formed by concaving a part of the larger-diameter portion 711, which part covers from an upper end of the portion 711 to a middle part of the portion 711 toward the smaller-diameter portion 712. The insertion part 714 covers from the smaller-diameter portion 712 to a lower end of the larger-diameter portion 711 and is defined as a frustoconical space which is gradually narrowed from the smaller-diameter portion 712 side to the larger-diameter portion 711 side. The insertion part 714 includes an upper end side communicating with the interior of the housing 713.

The cartridge body 71 encloses a first bearing 74, a second bearing 75, a retaining ring 76, a fixing member 77 and a magnet 78. The first bearing 74 is comprised of a rolling bearing such as a ball bearing, for example and is disposed in a part of the smaller-diameter portion 712, which part is a lower end of the insertion part 714. The retaining ring 76 is located under the first bearing 74 in the smaller-diameter portion 712. The first bearing 74 is fixed inside the smaller-diameter portion 712 by the retaining ring 76 so that the first bearing 74 is prevented from dropping out of the insertion part 714.

The second bearing 75 is comprised of a sliding bearing made of a metal alloy, for example. The second bearing 75 is disposed on the upper end of the insertion part 714, that is, on the bottom of the housing 713. The fixing member 77 is disposed on the upper surface of the second bearing 75 in the housing 713. The second bearing 75 is fixed to the bottom of the housing 713 by the fixing member 77 so as to be prevented from dropping out of the insertion part 714. The magnet 78 is located on the upper end of the insertion part 714 so as to be buried in the fixing member 77. A male thread 715 is formed in an outer periphery of the larger-diameter portion 711 so as to cover from the lower end of the larger-diameter portion 711 near the bottom of the housing 713.

The dog 72 is made of a resin and disposed on the upper end of the cartridge body 71 to close an upper opening of the housing 713. The dog 72 has a knob 721 which is composed of an arc-shaped curved surface having no plain surface. Accordingly, the cutter cartridge 70 lies down without being self-sustaining and with the cap 73 being directed, upward when detached from the cartridge holder 61 to be placed on a flat surface such as a table (not shown). Thus, the cutter 90 is prevented from being directed upward with the result that the user can safely handle the cutter cartridge 70.

The cap 73 is made of a resin and formed into a two-stage columnar shape such that the cap 73 has a lower part having a smaller diameter than an upper part as a whole. The cap 73 has a cap larger-diameter portion 731 formed into a cylindrical shape and a cap smaller-diameter portion 732 formed integrally with the larger-diameter portion 731. The larger-diameter portion 731 has an inner diameter which is slightly larger than an outer diameter of the body larger-diameter portion 711. The smaller-diameter portion has an inner diameter which is slightly larger than an outer diameter of the body smaller-diameter portion 712.

The cap smaller-diameter portion 732 has a lower end formed with a circular flat underside 735. The underside 735 contacts with the upper side of the object 110 thereby to press the object 110 when the object 110 is cut. The underside 735 has a circular hole 734 formed through a central part thereof. The hole 734 communicates between the inside and the outside of the cartridge cap 73. The cutter 90 attached to the chuck unit 80 is exposed through the hole 734 to the outside of the cap 73. A female thread 733 is formed inside the cap larger-diameter portion 731. The female thread 733 is configured to be brought into engagement with the male thread 715 formed on the outer periphery of the body larger-diameter portion 711.

In this case, a protrusion amount L designates an amount of protrusion of the distal end of the cap 73 through the hole 734. The protrusion amount L is thus adjusted in a following manner. That is, the user turns the cap 73 while the cartridge body 71 is held (fixed). As a result, the female thread 733 of the cap 73 is turned relative to the male thread 715 of the cartridge body 71. The cap 73 is then moved in the up-down direction relative to the cartridge body 71, so that the protrusion amount L of the cutter 90 is adjusted.

The cutter cartridge 70 includes a compression coil spring 73 disposed inside the cap larger-diameter portion 731 and outside the body smaller-diameter portion 712. The spring 79 is located between a lower end of the body larger-diameter portion 711 and the bottom of the cap larger-diameter portion 731. The cartridge body 71 and the cap 73 are urged by the spring 79 so as to depart from each other in the up-down direction. This can suppress loosening and backlash resulting from threading engagement of the male thread 715 and the female thread 733, with the result that the location of the cap 73 relative to the cartridge body 71, that is, the protrusion amount L of the cutter 90 can be adjusted accurately.

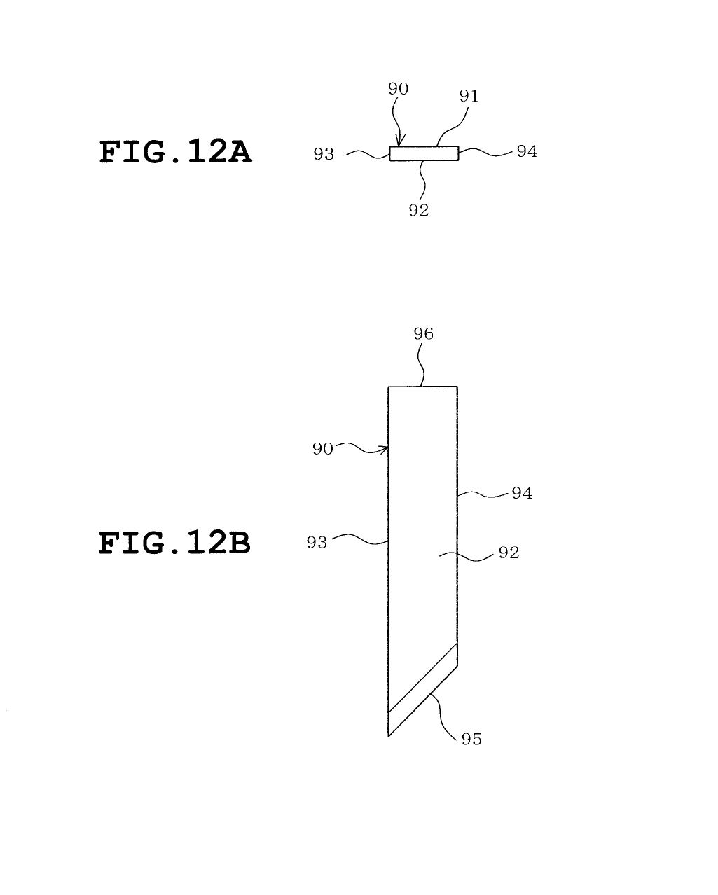

The chuck unit 80 is configured to hold the flat plate-shaped cutter 90 at one end (a lower end) thereof. The cutter 90 is formed into a substantially rectangular flat-plate shape and is long in one direction (in the up-down direction), as shown in FIG. 12B. The cutter 90 has two opposed surfaces, that is, a first surface 91 and a second surface 92, as shown in FIG. 12A. The cutter 90 also has two lengthwise extending edges, that is, a first side edge 93 and a second side edge 94.

The cutter 90 has a lengthwise end (a lower end) provided with a blade 95, The cutter 90 also has a proximal end 96 (an upper end) located opposite the blade 95. The blade 95 is tilted in a direction such that the blade 95 rises from the first side edge 93 to the second side edge 94. The blade 95 has a distal end which is acute-angled. The first surface 91, the second surface 92, the first side edge 93 and the second side edge 94 are at a right angle to the proximal end 96. The cutter 90 is formed by pressing a steel plate having a thickness of about 0.5 mm, for example and thereafter, a sharpening process is executed so that the blade 95 is obtained. Thus, the flat plats-shaped cutter 90 can be manufactured at low costs.

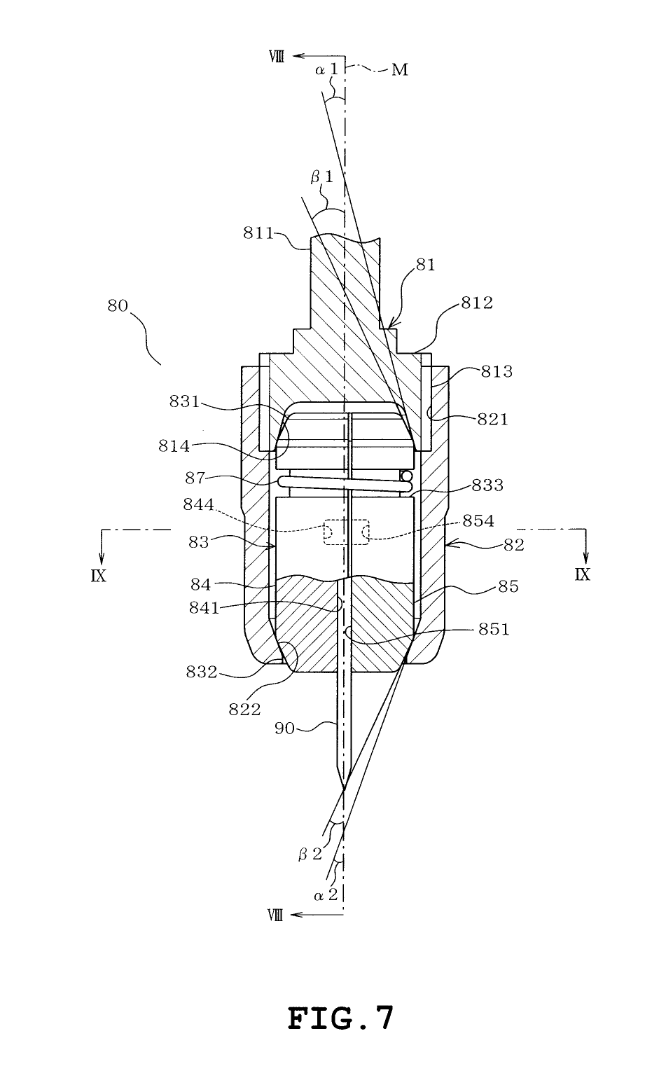

The chuck unit 80 includes a chuck shaft 81, a sleeve 82 and a chuck 83 as shown in FIGS. 7 to 9. The chuck shaft 81 is made of a metal and can accordingly he attracted by the magnet 78. The chuck shaft 81 includes a shaft portion 811 and an end 812 both formed integrally with each other. The shaft portion 811 is formed into a bar shape and is long in the up-down direction as a whole. The shaft portion 811 serves as a rotating shaft of the chuck unit 80. The end 812 is formed into a columnar shape and has a larger diameter than the shaft portion 811. The end 812 is located at the lower end side of the shaft portion 811. An alternate long and short dash line in FIGS. 4, 7 and 8 designates a rotational center line M which is a rotational center of the chuck shaft 81.

The end 812 of the chuck shaft 81 includes a first thread 813 and a first receiving portion 814. The first thread 813 is a male thread formed on an outer periphery of the end 812. The first receiving portion 814 is formed by recessing the end 812 into a tapered shape or a frustoconical shape such that the end 812 contracts from a part under the rotation center line M to the upper side. The first receiving portion 814 has a radial center line corresponding with the rotation center line M.

The sleeve 82 is formed into a cylindrical shape as a whole and disposed on an end 812 of the chuck shaft 81. The sleeve 82 has a radial center line corresponding with the rotation center line M. A second thread 821 and a second receiving portion 822 are disposed inside the sleeve 82. The second thread 821 is formed in an upper part of the sleeve 82 and is a female thread formed from the upper opening of the sleeve 82 to a downward midway part of the sleeve 82. The second thread 821 is brought into threading engagement with the first thread 813 of the end 812 of the chuck shaft 81.

Each of the first and second threads 813 and 821 is a right-hand thread. Accordingly, when the sleeve 82 is turned rightward while the chuck shaft 81 is prevented from rotation, the sleeve 82 is moved upward or in a direction such that the sleeve 82 comes closer to the chuck shaft 81. On the other hand, the sleeve 82 is moved downward, that is, in a direction such that the sleeve 82 departs from the chuck shaft 81 when turned leftward with the chuck shaft 81 being prevented from rotation. Thus, the first and second threads 813 and 821 function as a connection unit which connects the sleeve 82 to the chuck shaft 81 so that the sleeve 82 is axially movable with respect to the shaft portion 811.

The second receiving portion 822 is formed on the lower part of the sleeve 82 or so as to be located opposite the chuck shaft 81. The sleeve 82 is tapered or formed into a frustoconical shape such that an inner circumferential surface of the sleeve 82 is downwardly reduced. The second receiving portion 822 has an axial center line corresponding with the rotation center line M. When reference symbol α1 designates an angle made between a surface (an inclined surface) of the first receiving portion 814 and the rotation center line M and reference symbol α2 designates an angle made between a surface (an inclined surface) of the first receiving portion 814 and the rotation center line M, angle α1 is set to be smaller than angle α2.

The chuck 83 is disposed inside the sleeve 82. The chuck 83 is formed by combining first and second chuck members 84 and 85 into a vertically long pillared shape or in this case, a columnar shape as a whole. More specifically, the first and second chuck members 84 and 85 are shaped so as to be obtained by dividing a columnar member along the rotation center line M into two parts. The chuck 83 has an outer diameter smaller than an inner diameter of the sleeve 82.

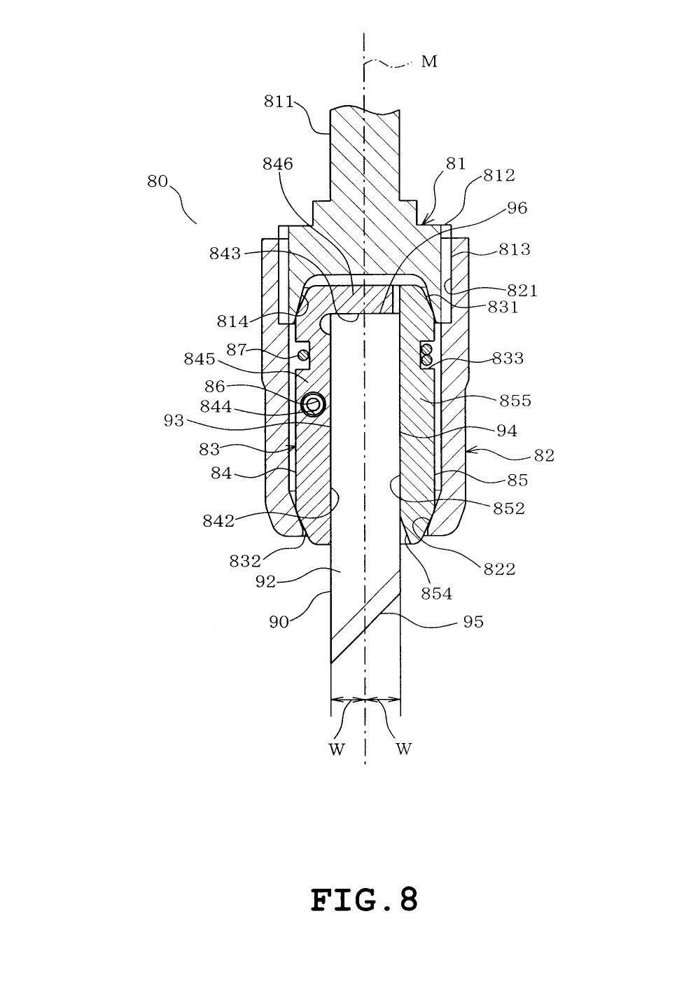

The chuck 83 has two ends formed with first and second tapered portions 831 and 832 respectively as shown in FIGS. 7 and 8. The first tapered portion 831 corresponds to the first receiving portion 814 while the second tapered portion 832 corresponds to the second receiving portion 822. The first tapered portion 831 is formed on the upper end of the chuck 83, that is, the end located, at the chuck shaft 81 side. The first tapered portion 831 is tapered or formed into a frustoconical shape such that the first tapered portion 831 is reduced upward, that is, to the chuck shaft 81 side. When reference symbol β1 designates an angle made between an outer periphery of the first tapered portion 831 and the rotation center line M, angle β1 is set to be equal to or larger than angle α1. The first tapered portion 831 is in contact with an inner periphery of the first receiving portion 814.

The second tapered portion 832 is disposed on the lower end of the chuck 83, that is, the end located opposite the chuck shaft 81. The second tapered portion 832 is tapered or formed into a frustoconical shape such that the second tapered portion 832 is reduced downward or to the side opposite the chuck shaft 81. When reference symbol β2 designates an angle made between an outer periphery of the second tapered portion 832 and the rotation center line M, angle β2 is set to be equal to or larger than angle α2. The second tapered portion 832 is in contact with an inner periphery of the second receiving portion 322. Angles β1 and β2 are set to the same value.

A retaining groove 833 is formed in an outer periphery of the chuck 83 so as to extend over the first and second chuck members 84 and 85. The retaining groove 833 is located closer to the chuck shaft 81 than to the lengthwise center of the chuck 83. The retaining groove 833 is formed by concaving an outer periphery of the chuck 83 in the direction of the radial center of the chuck 83 over entire first and second chuck members 84 and 85 so as to have a rectangular section.

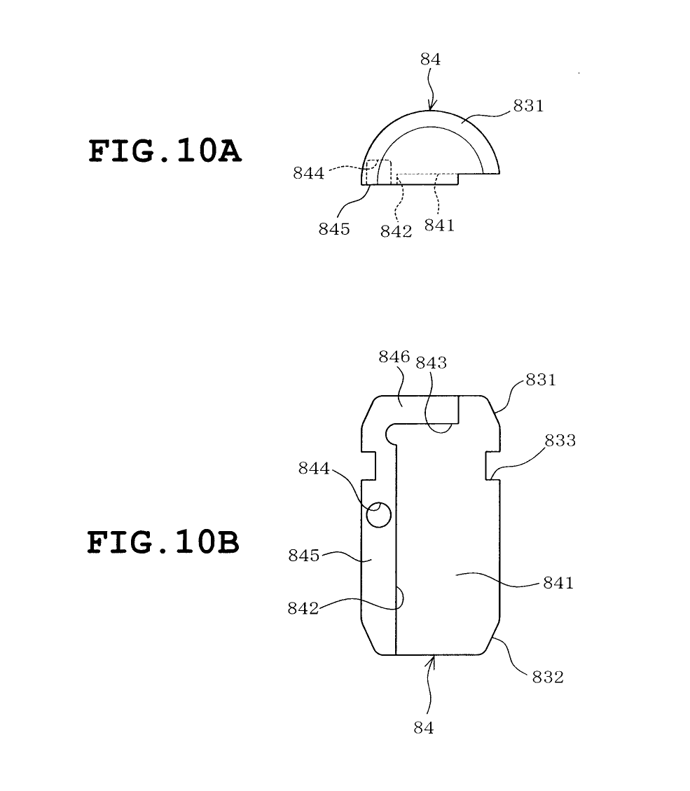

The first chuck member 84 includes a first contact portion 841, a first contact side edge 842, an abutment 843 and a first containing portion 844, as shown in FIGS. 10A and 10B. The first contact surface 841 is formed by concaving an axial surface of a semicircular column into a planar shape except for a part thereof or more specifically, a lengthwise extending front side edge 845 and an upper side edge 846 continuous from an upper part of the edge 845. The first contact side edge 842 is formed into a wall comprised of a stepped portion between the front side edge 845 and the first contact portion 841. The abutment 843 is formed into a wall comprised of a stepped portion between the upper edge 846 and the first contact portion 841.

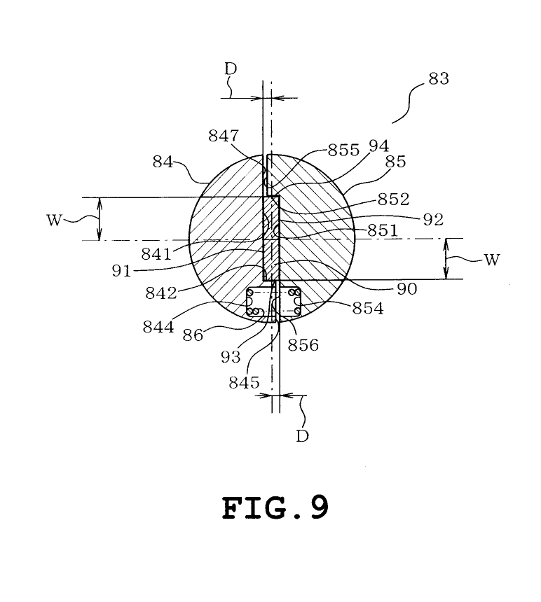

The cutter 90 is held between the first and second chuck members 84 and 85 as shown in FIG. 9. In this case, distance D from the first contact portion 841 to the center of the chuck 83 is substantially equal to a thickness of the cutter 90. Furthermore, distance W from the first contact side edge 842 to the center of the chuck 83 is substantially equal to a half of the width of the cutter 90.

The first containing portion 844 is a non-through hole in which a compression spring 86 is to be mounted as will be described later. The first containing portion containing portion 844 is defined in the front edge 845 so as to be located below the retaining groove 833 and slightly above the vertical center of the chuck 83.

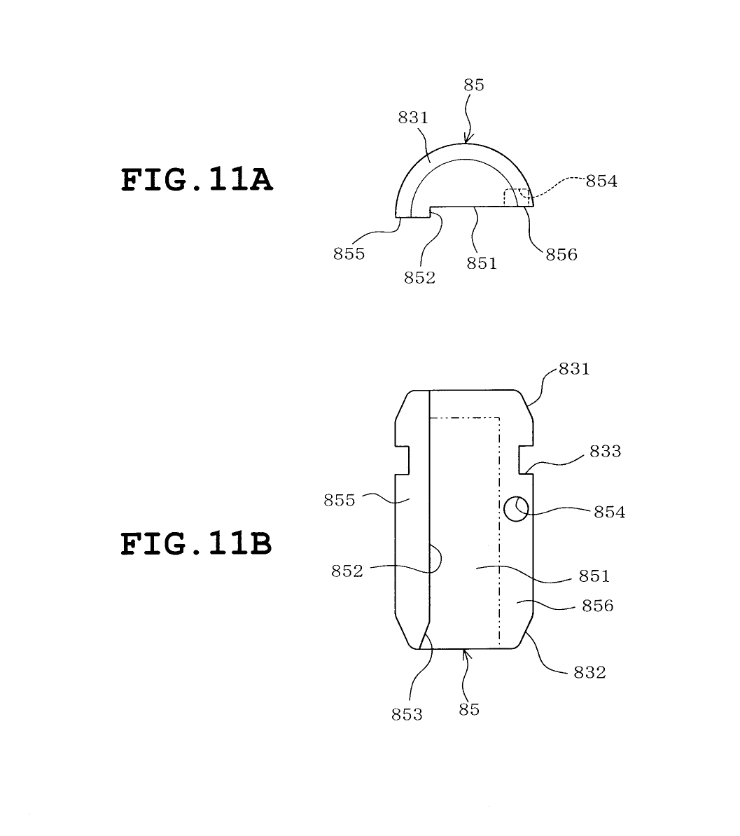

The second chuck member 85 includes a second flat contact surface 851, a second contact side edge 852, a guide 853 and a second containing portions 854, all of which are formed integrally with one another, as shown in FIGS. 11A and 11B. More specifically, the second contact surface 851 is formed by concaving an axial surface of a semicircular column into a planar shape except for a part thereof or more specifically, a lengthwise extending rear edge 855. The second contact side edge 852 is a wall including a stepped portion between the rear edge 855 and the second contact surface 851. In this case, distance D from the second contact surface 851 to the center of the chuck 83 is substantially equal to the thickness of the cutter 90 as shown in FIG. 9. Furthermore, distance W from the first contact side edge 842 to the center of the chuck 83 is substantially equal to a half of the width of the cutter 90. A second outer flat surface 856 is a part that is coplanar with the second contact surface 851 and does not contact with the cutter 90, namely, a part shown by an alternate long and two short dashes line in FIG. 11B.

The second containing portion 854 is a non-through hole in which the compression spring 86 is to be mounted as will be described later. The second containing portion 854 is defined in a second outer flat surface 856 so as to be located below the retaining groove 833 and slightly above the vertical center of the chuck 83. The first and second, containing portions 844 and 854 are adapted to be opposed to each other when the first and second chuck members 84 and 85 are combined together. The compression spring 86 and the annular member 87 are mounted when the first and second chuck members 84 and 85 are combined together. The compression spring 86 is mounted over the first and second containing portions 844 and 854 as shown in FIG. 9. The compression spring 86 urges the first and second chuck members 84 and 85 so that both chuck members 84 and 85 depart from each other. Thus, the compression spring 86 functions as an urging unit which urges the first and second chuck members 84 and 85 so that both chuck members 84 and 85 depart from each other.

The annular member 87 is a one-turn coil spring, for example, as shown in FIGS. 7 and 8. The annular member 87 is mounted in the retaining groove 833 to retain the first end second chuck members 84 and 85. In more detail, the annular member 87 retains the first contact portions 841 and 842 of the first chuck member 84 and the second contact surfaces 851 and 852 of the second chuck member 85 in an opposed state. Thus, the retaining groove 833 and the annular member 87 function as a retaining unit. The annular member 87 may be a rubber O-ring or a metal ring, instead of the coil spring.

The cutter 90 is held between the first and second chuck members 84 and 85. On this occasion, the cutter 90 is disposed so that the proximal end 96 thereof abuts against the abutment 843 of the first chuck member 84 as shown in FIG. 8. The first surface 91 of the cutter 90 then contacts with the first contact portion 841 of the first chuck member 84 as shown in FIG. 9. Furthermore, the first side edge 93 of the cutter 90 contacts with the first contact side edge 842 of the first chuck member 84. Thus, the first contact portion 841 and the first contact side edge 842 function as a first contact which contacts with one surface 91 and one side edge 93 of the flat plate-shaped cutter 90.

In this case, furthermore, the second surface 92 of the cutter 90 contacts with the second contact surface 851 of the second chuck member 85, and the second side edge 94 of the cutter 90 contacts with the second contact side edge 852 of the second chuck member 85. Thus, the second contact surface 851 and the second contact side edge 852 function as a second contact which contacts with the other surface 92 and the other side edge 94 of the flat plate-shaped cutter 90.

Still furthermore, the first and second chuck members 84 and 85 do not contact with each other when the cutter 90 is held by the first and second chuck members 84 and 85, as shown in FIG. 9. In this case, the thicknesswise and widthwise centers of the cutter 90 correspond with the radial center of the chuck 83 even when the first side edge 93 of the cutter 90 is disposed at the first contact side edge 842 side of the first chuck member 84 or at the second contact side edge 852 side of the second chuck member 85.

The rotation center line M thus passes the thicknesswise and widthwise centers of the cutter 90 and the radial center of the chuck 83. Accordingly, the thicknesswise and widthwise centers of the cutter 90 correspond with the rotation center of the shaft portion 811 of the chuck shaft 81 even when the cutter 90 is held in either direction. In other words, the cutter 90 may be held on the chuck 83 in either direction.

A procedure of replacing one cutter 90 with another will now be described. Firstly, the user turns the sleeve 82 leftward while holding the shaft portion 811 of the chuck shaft 81 to prevent rotation of the chuck shaft 81. The sleeve 82 is then moved in the direction such that the sleeve 82 departs from the chuck shaft 81 or downward. Upon downward movement of the sleeve 82, the chuck 83 is gradually rendered movable in the up-down direction. However, since compression spring 86 normally urges the first and second chucks 84 and 85 in the direction of departing from each other, the downward movement of the sleeve 82 gradually moves the first and second chuck members 84 and 85 in the direction of departing from each other. As a result, a gap between the first contacts 841 and 842 and the second contact surfaces 851 and 852 is increased to allow the cutter 90 to be inserted thereinto.

The user then inserts the cutter 90 into the gap between the first contacts 841 and 842 and the second contact surfaces 851 and 852 from below the chuck 83 with the blade 95 being directed downward. On this occasion, while being guided by the guide portion of the second chuck member 85, the cutter 90 is inserted into the gap until abutting against the abutment 843 of the first chuck member 84. Thereafter, the user turns the sleeve 82 rightward with the chuck shaft 81 being prevented from rotation, whereby the sleeve 82 is moved so as to come closer to the chuck shaft 81 (upward).

The chuck 83 gradually becomes unable to move in the up-down direction as the result of the upward movement of the sleeve 82. Thereafter, when the sleeve 82 is turned rightward thereby to be moved upward, the chuck 83 is subjected to a force in the compression direction at the first and second, tapered portions 831 and 832 since the chuck 83 is held between the first receiving portion 814 of the chuck shaft 81 and the second receiving portion 822 of the sleeve 82.

Each of the first and second tapered portions 831 and 832 of the chuck 83 is formed into the tapered shape or inclined in the axial direction of the chuck shaft 81. Accordingly, when subjected to the force in the compression direction while the chuck 83 is prevented from axial movement (up-down direction), the first and second tapered portions 831 and 832 convert part of the force to a component force directed to the axial center side of the chuck 83, transmitting the component force to the chuck 83, that is, the first and second chuck members 84 and 85. Thus, the first tapered portion 831 and the first receiving portion 814, and the second tapered portion 832 and the second receiving portion 822 function as a conversion unit.

The first and second chuck members 84 and 85 are subjected to the force directed to the axial center side of the chuck 83 thereby to press the cutter 90. In this case, the first surface 91 of the cutter 90 is pressed against the first contact surface 841 of the first chuck member 84 and the second contact surface 92 of the cutter 90 is pressed against the second contact surface 851 of the second chuck member 85. Furthermore, the first side edge 93 of the cutter 90 is pressed against the first side edge 842 of the first chuck member 84 and the second side edge 94 of the cutter 90 is pressed against the second contact side edge 852 of the second chuck member 85. Thus, the cutter 90 is uniformly pressed toward the radial center of the chuck 83 by the first and second chuck members 84 and 85. Consequently, the cutter 90 is held by the chuck 83 in a posture in which the center position of the cutter 90 corresponds with the center position of the chuck 83.

Subsequently, the chuck unit 80 holding the cutter 90 is attached to the cartridge body 71. On this occasion, the user passes the shaft portion 811 of the chuck shaft 81 through the first and second bearings 74 and 75. The chuck shaft 81 is then held in the state where an upper end of the shaft portion 811 thereof is attracted by the magnet 78. As a result, the chuck unit 80 is rotatably attached to the cartridge body 71. The user then attaches the cap 73 to the cartridge body 71 to turn the cap 73, thereby adjusting a protrusion amount L of the cutter 90.

As described above, the flat plate-shaped cutter 90 is fixed to the chuck 83 while pressed from all around in the center direction of the shaft portion 811 of the chuck shaft 81. Accordingly, even when repeatedly attached to and detached from the chuck 83, the cutter 90 is fixed at the predetermined position in each case. This can prevent displacement of the distal end of the blade 95 due to replacement of the cutter 90. Furthermore, the cutter 90 can easily be fixed at the predetermined position on the chuck unit 80 when the sleeve 82 is just moved in the axial direction of the shaft portion 811 of the chuck shaft 81 in the replacement of the flat plate-shaped cutter 90. This can improve the working efficiency in the replacement of the cutter 90.

The cutter cartridge 70 is provided with the conversion unit, which is configured to convert the movement of the sleeve 82 and the chuck shaft 81 in the direction of coming close to each other to the movement in the central direction of the shaft portion 811, transmitting the converted movement to the first and second chucks 84 and 85. The conversion unit includes the first tapered portion 831 of the chuck 83 and the first receiving portion 814 of the chuck shaft 81, and the second tapered portion 832 of the chuck 83 and the second receiving portion 822 of the sleeve 82. Consequently, the configuration of the conversion unit can be simplified.

The cutter cartridge 70 is provided with the connection unit, which is configured to connect the sleeve 82 to the chuck shaft 81 so that the sleeve 82 is movable in the axial direction of the shaft portion 811. The connection unit includes the first thread 813 provided on the chuck shaft 81 and the second thread 821 provided on the sleeve 82. Consequently, the construction of the conversion unit can be simplified.

The cutter cartridge 70 includes the compression coil 86 serving as the urging unit. The compression spring 86 is configured to urge the first and second chucks 84 and 85 so that first contacts 841 and 841 depart from the second contact surfaces 851 and 852. According to this construction, the urging force of the compression spring 86 can cause the first and second contacts to depart from each other. Consequently, the cutter 90 can easily be inserted into and detached from the gap between the first and second contact surfaces 841 and 851, with the result that the working efficiency can be improved.

The first containing portion 844 formed into the non-through hole is provided in the part of the first chuck member 84, except for the first contacts 841 and 842. The second containing portion 854 formed into the non-through hole is provided in the part of the second chuck member 85 except for the second contact surfaces 851 and 852. When the first and second chuck members 84 and 85 are combined together, the compression spring 86 is mounted in the first and second containing portions 844 and 854 when the first and second containing portions 844 and 854 are located at opposed positions. Since the urging unit includes the first and second containing portions 844 and 854 and the compression spring 86, the construction of the urging unit can be simplified.

The cutter cartridge 70 includes the holding unit which is configured to bold the first contact surfaces 841 and 842 and the second contact surfaces 851 and 852 in the opposed state. According to this construction, even when the sleeve 82 is completely detached from the chuck shaft 81 so that the chuck 83 stands alone, the first and second, chuck members 84 and 85 can be prevented from being separated from each other, with the result that the handling of the cartridge holder can be rendered easier.

The holding unit further includes the retaining groove 833 formed over the first acid second chuck members 84 and 85 and the annular member 87 such as the coil spring. Consequently, the construction of the holding unit can be simplified.

The retaining groove 833 is located nearer to the end of the chuck shaft 81 than to the axial center of the shaft portion 811 of the chuck shaft 81. More specifically, the retaining groove 833 is provided at the first tapered portion 831 side in the chuck 83. On the other hand, the first and second containing portions 844 and 854 are located near the end of the chuck shaft 81, which end is opposed to the chuck shaft 81 in the axial direction of the shaft portion 811 of the chuck shaft 81. More specifically, the first and second containing portions 844 and 854 are provided at the second tapered portion 832 side in the chuck 83. According to this construction, the first and second chuck members 84 and 85 include respective portions located at the lower end side of the chuck 83, that is, at the second tapered portion 832 side, which portions are opened to a larger extent by the compression spring 86. Consequently, the cutter 90 can easily be inserted and detached.

The chuck 83 is configured so that the thicknesswise and widthwise centers of the cutter 90 correspond with the rotation center of the chuck 83 even when the cutter is held in any direction. More specifically, the cutter 90 may be held on the chuck 83 in any direction. Accordingly, the user can easily replace the cutter 90 without being aware of the direction of the cutter 90.

The angle α2 made between the surface of the second receiving portion 822 of the sleeve 82 and the rotation center line M is larger than the angle α1 made between the surface of the first receiving portion 814 of the chuck shaft 81 and the rotation center line M. This construction increases a ratio of the component force directed toward the axial center of the chuck 83 to the force acting from the second receiving portion 822 of the sleeve 82 to the second tapered portion 832 of the chuck 83. Consequently, the chuck 83 can press the cutter 90 in the direction of the radial center thereof at the second tapered portion 832 and can efficiently press the first tapered portion 831 against the first receiving portion 814.

Thus, the angle α1 is smaller than the angle α2. This construction increases a ratio of the component force directed toward the axial center of the chuck 83 to the force the first tapered portion 831 of the chuck 83 receives from the first receiving portion 814 of the chuck shaft 81. Consequently, the chuck 83 can more rigidly hold the proximal end side of the cutter 90 at the first tapered portion 831.

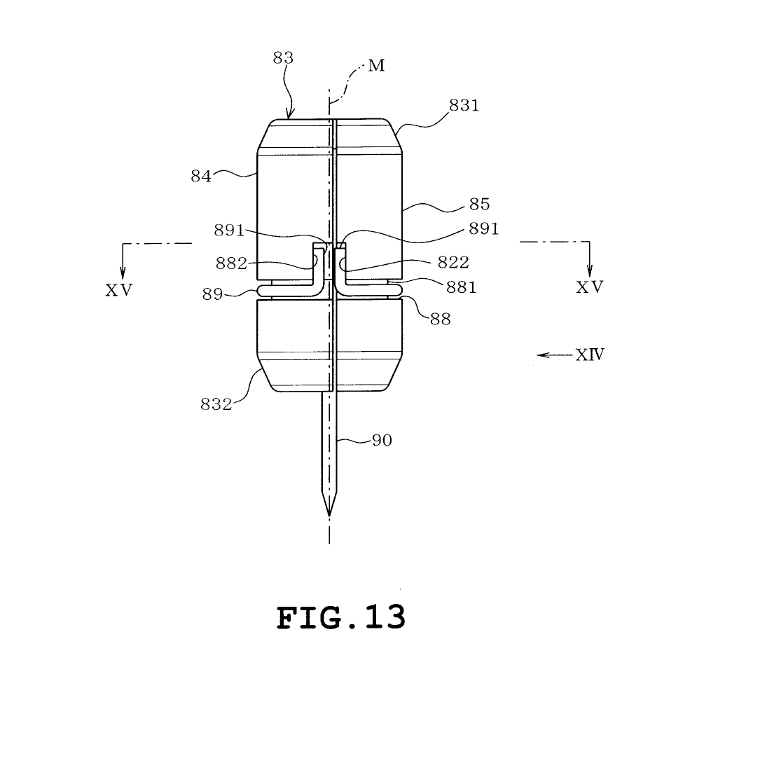

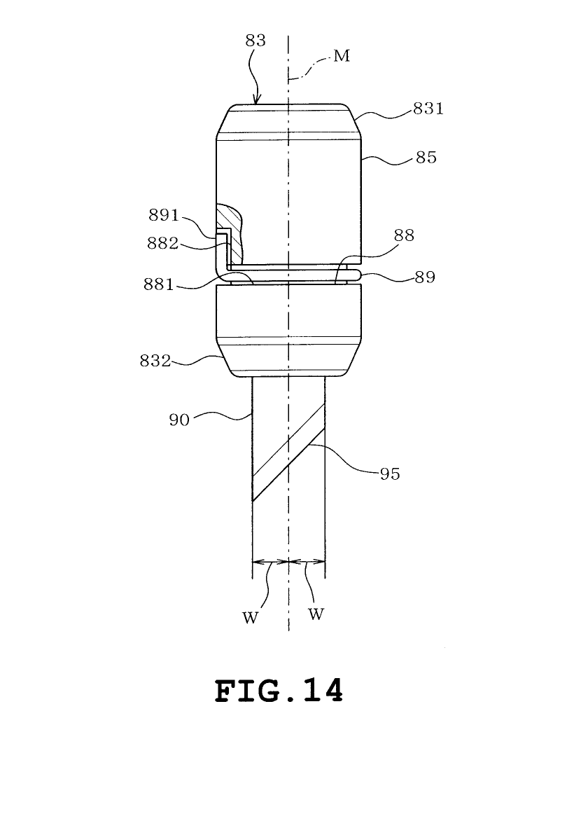

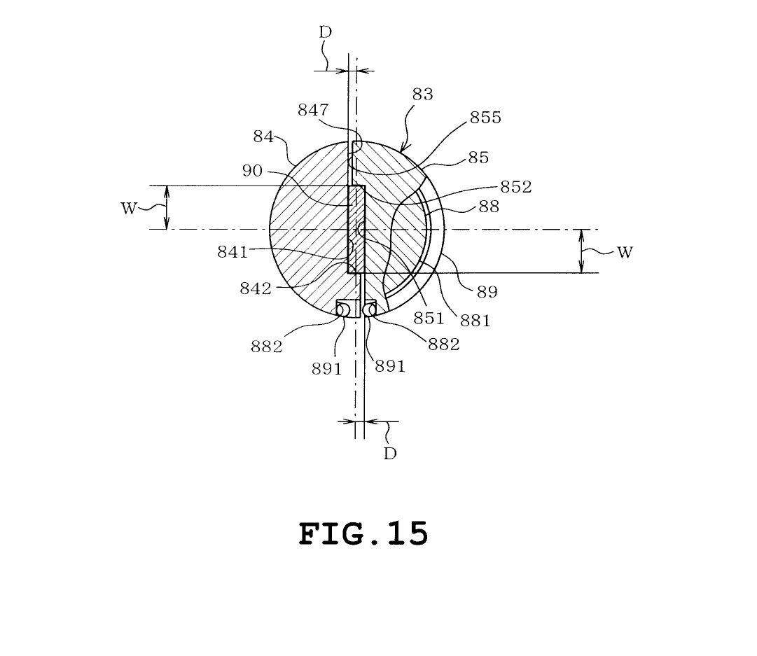

FIGS. 13 to 15 illustrate a second example. The second example differs from the first example in the construction of the urging unit constructed by the first and second containing portions 844 and 854 and the compression spring 86. More specifically, the urging unit is constructed of a retaining groove 88 and a spring member 89 in the second example. The other construction in the second example is identical with the first example. Accordingly, identical or similar parts in the second example are labeled by the same reference symbols as those in the first example, and the description of these identical parts will be eliminated.

The retaining groove 88 is formed closer to the end of the chuck 83 located opposite the chuck shaft 81 than the axial center of the chuck shaft 81. More specifically, the retaining groove 88 includes a main groove 881 and locking grooves 882. The main groove 881 is formed by concaving the outer periphery of the chuck 83 in the direction of the radial center of the chuck 83 into a rectangular groove shape, so chat the main groove 881 extends over an entire outer periphery of the chuck 83 or over the first and second chuck members 84 and 85. The locking grooves 882 are formed in boundaries of the first and second chuck members 84 and 85 respectively and are continuous to the main groove 881.

The spring member 89 is attached in the retaining groove 88 and formed of, for example, a wire spring into a substantially C-shape in a planar view. The spring member 89 has both ends formed with upwardly bent locking portions 891 respectively. The locking portion 891 is in engagement with the locking grooves 882. When subjected to a force reducing a gap between the two locking portions 891, the spring member acts against the force so as to return the gap between the locking portions 891 to the former state. Thus, the spring member 89 urges the first and second chuck members 84 and 85 in the direction such that the first and second contact surfaces 841 and 851 depart from each other.

Furthermore, the first and second chuck members 84 and 85 are retained in respective positions by the spring member 89. In more detail, the first chuck member 84 also serves as the holding unit which holds the first and second contact portions 841 of the first and second chuck members 84 and 85 in the opposed positions respectively.

According to the above-described construction, the second example can achieve the same advantageous effects as those of the first example. Furthermore, since the spring member 89 also serves the holding unit holding the first and second chuck members 84 and 85 in the respective positions, the construction of the chuck 83 can be simplified. This can reduce the number of parts of the chuck unit 80 with the result of cost reduction.

The above-described examples should not be restrictive but may be modified or expanded without departing from the technical scope of the invention.

The tapered portions of the chuck 83 serving as the conversion unit may not be located at both ends of the chuck 83 but may be formed on one of the ends of the chuck.

The chuck 83 need not be formed into the columnar shape but may be formed into, for example, a polygonal shape such as a hexagonal or octagon shape.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutter cartridge comprising:
a chuck shaft having a shaft portion about which a carriage of a cutting apparatus is rotated, the chuck shaft having an end;
a sleeve which is cylindrical in shape and provided in the end of the chuck shaft;
a connection unit configured to connect the sleeve to the chuck shaft so that the sleeve is movable in an axial direction of the shaft;
a chuck provided inside the sleeve and configured into a columnar shape by combining a first chuck member formed with a first contact contacting with one of flat sides and a side edge of the cutter and a second chuck member formed with a second contact contacting with the other flat side and the side edge of the cutter, the chuck exposing the cutter from an end located opposite the chuck shaft to hold the cutter between the first and second contacts, the chuck causing the cutter to face an outside of the sleeve from an end of the sleeve located opposite the chuck shaft; and
a conversion unit configured to convert movement of the sleeve and the chuck shaft in a direction such that both come close to each other to movement in a direction of a center of the shaft, transmitting the converted movement to the first and second chuck members.

2. The cutter cartridge according to claim 1, wherein the conversion unit includes a tapered portion which is located on at least one of ends of the chuck and formed into a frustoconical shape such that the tapered portion contracts toward a distal end side of the end and a receiving portion formed on either the chuck shaft or the sleeve that corresponds to the tapered, portion.

3. The cutter cartridge according to claim 2, wherein the conversion unit includes a first tapered portion which is located on an end of the chuck and formed into a frustoconical shape and a first receiving portion which is formed on the chuck shaft so as to contact with the first tapered portion and a second tapered portion which is located on a chuck end located opposite the chuck shaft of the chuck and formed into a frustoconical shape such that the second tapered potion contracts toward a side opposite the chuck shaft and a second receiving portion which is formed on the sleeve so as to contact with the second tapered portion.

4. The cutter cartridge according to claim 2, wherein the conversion unit includes:
a first tapered portion which is located on an end of the chuck at the chuck shaft side and formed into a frustoconical shape such that the first tapered portion contracts toward the chuck shaft side and a first receiving portion which is formed on the chuck shaft and contacts with the first tapered portion; and
a second tapered portion located on an end of the chuck at a side located opposite the chuck shaft and formed into a frustoconical shape such that the second tapered portion contracts to the side opposite the chuck shaft and a second receiving portion which is formed on the sleeve so as to contact with the second tapered portion.

5. The cutter cartridge according to claim 1, wherein the connection unit includes a first thread provided on the chuck shaft and a second thread which is provided on the sleeve so as to threadingly engage the first thread.

6. The cutter cartridge according to claim 2, wherein the connection unit includes a first thread provided on the chuck shaft and a second thread which is provided on the sleeve so as to threadingly engage the first thread.

7. The cutter cartridge according to claim 3, wherein the connection unit includes a first thread provided on the chuck shaft and a second thread which is provided on the sleeve so as to threadingly engage the first thread.

8. The cutter cartridge according to claim 4, wherein the connection unit includes a first thread, provided on the chuck shaft and a second thread which is provided on the sleeve so as to threadingly engage the first thread.

9. The cutter cartridge according to claim 1, further comprising an urging unit which urges the first and second contact portions in a direction such that the first and second contact portions depart from each other relative to the first and second chuck members.

10. The cutter cartridge according to claim 2, further comprising an urging unit which urges the first and second contact portions in a direction such that the first and second contact portions depart from each other relative to the first and second chuck members.

11. The cutter cartridge according to claim 3, further comprising an urging unit which urges the first and second contact portions in a direction such that the first and second contact portions depart from each other relative to the first and second chuck members.

12. The cutter cartridge according to claim 4, further comprising an urging unit which urges the first and second contact portions in a direction such that the first and second contact portions depart from each other relative to the first and second chuck members.

13. The cutter cartridge according to claim 9, wherein the urging unit includes:
a first containing portion formed in a part of the first chuck member except for the first contact portion so as to have a non-through hole shape;
a second containing portion formed in a part of the second chuck member except for the second contact portion so as to have a non-through hole shape, said part being opposed to the first housing; and
a compression spring provided over the first and second housings.

14. The cutter cartridge according to claim 1, further comprising a retaining unit configured to retain the first contact of the first chuck member and the second contact of the second chuck member in an opposed state.

15. The cutter cartridge according to claim 14, wherein the retaining unit includes:
a retaining groove formed by concaving an outer periphery of the chuck over the first and second chuck members; and
an annular member attached to the retaining groove to retain the first and second contacts of the first and second chuck members respectively in the opposed state.

16. The cutter cartridge according to claim 9, wherein the urging unit includes:
a containing groove formed by concaving an outer periphery of the chuck over the first and second chuck members; and
a spring member attached to the containing groove and urging the first and second contacts so that the first and second contacts depart from each other,
wherein the urging unit also serves as a retaining unit configured to retain the first and second contacts of the first and second chuck members respectively in the opposed state.

17. The cutter cartridge according to claim 16, wherein the containing groove is formed closer to the end opposed to the chuck shaft than to an axial center of the shaft.

18. The cutter cartridge according to claim 1, wherein when the flat cutter is held between the first and second, contacts, a thicknesswise center and a widthwise center of the flat cutter correspond with a center of rotation.

19. A cutting apparatus comprising:
a carriage provided with a cartridge holder to which a cutter cartridge is detachably attachable; and
a moving unit configured to move an object to be cut and the carriage relative to each other, the cutter cartridge including:
a chuck shaft having a shaft portion about which the carriage is rotated, the chuck shaft having an end;
a sleeve which is cylindrical in shape and provided in the end of the chuck shaft;
a connection unit configured to connect the sleeve to the chuck shaft so that the sleeve is movable in an axial direction of the shaft;
a chuck provided inside the sleeve and configured into a columnar shape by combining a first chuck member formed with a first contact contacting with one of flat sides and a side edge of the cutter and a second chuck member formed with a second contact contacting with the other flat side and the side edge of the cutter, the chuck exposing the cutter from an end located opposite the chuck shaft to hold the cutter between the first and second contacts, the chuck causing the cutter to face an outside of the sleeve from an end of the sleeve located opposite the chuck shaft; and
a conversion unit configured to convert movement of the sleeve and the chuck shaft in a direction such that both come close to each other to movement in a direction of a center of the shaft, transmitting the converted movement to the first and second chuck members.
